(19) United States
(12) Patent Application Publication
(10) Pub. No.: US 2003/0005137 A1
(43) Pub. Date: Jan. 2, 2003

(54) Management protocol for network apparatus

(76) Inventor: Wei-Che Yu, Hsinchu (TW)

Correspondence Address: BACON & THOMAS, PLLC, 625 SLATERS LANE, FOURTH FLOOR, ALEXANDRIA, VA, 22314

(21) Appl. No.: 09/894,128

(22) Filed: Jun. 29, 2001

(51) Int. Cl. G06F 15/16; G06F 15/173

(52) U.S. Cl. 709/230; 709/223

(57) ABSTRACT

The invention is a Network Apparatus Management Protocol, the said Protocol is used to make a network management tool capable of establishing a one-client-multi-server mode together with all the network apparatuses on the same network, thereby the said management tool plays the role of one-client in the said mode while the said network apparatus plays the role of multi-server, and to make the said network apparatus, through the said Protocol, assign a special communication port number in the header of a User Datagram Protocol as the port number to be based for receiving the request from the client end so as to enable the said client end to achieve the purpose of managing all the network apparatuses on the same network.

### BACKGROUND OF THE INVENTION

Presently, many businesses use the area network or the Internet to conduct internal information flow. In order to enable their network management personnel to efficiently manage numerous network apparatuses on the network, usually the following methods are utilized to conduct setting and management for the network apparatuses on the network:

1. A RS-232 connection port is provided by each of the network apparatuses to enable the management personnel to use the super terminal, via the signal line, to directly get on-line with the RS-232 connection port of the network apparatus, then to utilize the network management application program installed on the super terminal to log on the preset window of the network apparatus for directly conducting every item of setting or modification. The shortcoming of this kind of management method is that the management personnel have to go directly to each of the network apparatuses to conduct setting or modification. Therefore, wherever the network apparatuses are located, the management personnel have to go to that locations to conduct setting or modification, that causes tremendous manpower and time waste and is unable to make the network management personnel fulfill controlling over the remote network apparatuses.

2. Simple Network Management Protocol (SNMP) is adapted to enable the network management personnel to use a computer to get on-line from a remote end and to log on the preset window of each of the network apparatuses via the network to conduct setting, modification and management. The shortcoming of this kind of setting method is that the management personnel have to know specifically the IP destination address of each network apparatus to correctly log on the preset window installed therein, furthermore, none of the network apparatuses should have the same IP destination address as that of the other network apparatus, so the network management personnel not only need to know the preset IP destination address of every network apparatus, but also have to have the concept and ability of IP setting and management.

3. TELNET is adapted to conduct every item of setting and management for every network apparatus via the Internet. The shortcoming of it is that the network management personnel not only have to know the preset IP destination address of every network apparatus, but also have to have the concept and ability of IP setting and concept.

4. Web server is established in between the network apparatuses to enable the network management personnel to conduct every item of setting and management for each network apparatus through the Web browser and via the Internet. Again, the shortcoming of it is that the network management personnel have to have the concept of IP setting and management and know the IP destination address of every network apparatus.

Additionally, when the mentioned network management personnel are conducting setting or modification for the network apparatuses via the network, the mentioned network management personnel have to look up the IP destination address of the first network apparatus, log on the set window and conduct setting, then log off; then they look up the IP destination address for the next network apparatus, log on, conduct setting then log off; they execute repeatedly until the setting for all the network apparatuses is accomplished. Therefore, if there are ten network apparatuses, the said management personnel have to conduct the similar setting operation for ten times, furthermore, if the setting needs to be changed later on, the mentioned setting operation (including the management end and the user's end) has to be conducted all over again and that is really a task consuming an extreme amount of manpower and time.

Therefore, how to simplify the operation of the setting and management for the said network apparatus more so as to save manpower and shorten the operation time to enable the management end to easily and rapidly conduct every item of management for the various types of network apparatuses distributed in every where has become an important subject to be solved in the network apparatus management.

### SUMMARY OF THE INVENTION

In view of the above mentioned reasons, in order to improve the numerous shortcomings occurred in the setting and management of the mentioned traditional network apparatuses, the inventor of the present invention, following long endeavor to research and experiment, finally culminated in the development of the present invention of the Network Apparatus Management Protocol (or Network Equipment Arrangement Protocol, hereinafter referred as NEAP), the said NEAP is used to make a network management tool capable of establishing a one-client-multi-server mode together with all the network apparatuses on the same network, thereby the said management tool plays the role of one-client in the said mode while the said network apparatus plays the role of multi-server, and to make the said network apparatus, through the said NEAP, assign a special communication port number in the header of a User Datagram Protocol (hereinafter referred as UDP) as the port number to be based for receiving the request from the client end so as to enable the said client end to achieve the purpose of managing all the network apparatuses on the same network.

Another purpose of the present invention is that the said protocol enables the request packet of the client end to work as the UDP destination port number based on the assigned UDP communication port number and to set the UDP source port number according to the mechanism at the client end, therefore, after receiving the said request packet and accomplishing the operation requested to be conducted, each of the network apparatuses can exchange the said UDP destination port number and the said UDP source port number, then transmits the said request packet back to the client end by broadcasting thereby to enable the said client end to easily get or set data in every network apparatus.

### BRIEF DESCRIPTION OF THE DRAWINGS

FIG. 1 is a schematic drawing of a network mode of one-client-multi-server established by utilizing the NEAP of the present invention.

FIG. 2 is a schematic drawing of the frame of the NEAP of the present invention.

FIG. 3 is a schematic drawing of the header column of the NEAP of the present invention.

FIG. 4 is a schematic drawing of the data column of the NEAP of the present invention.

FIG. 5 is a schematic drawing of the reciprocating operation of the packet when the client end utilizes the NEAP of the present invention to conduct management for the said every network apparatus.

### DETAILED DESCRIPTION OF THE PREFERRED EMBODIMENTS

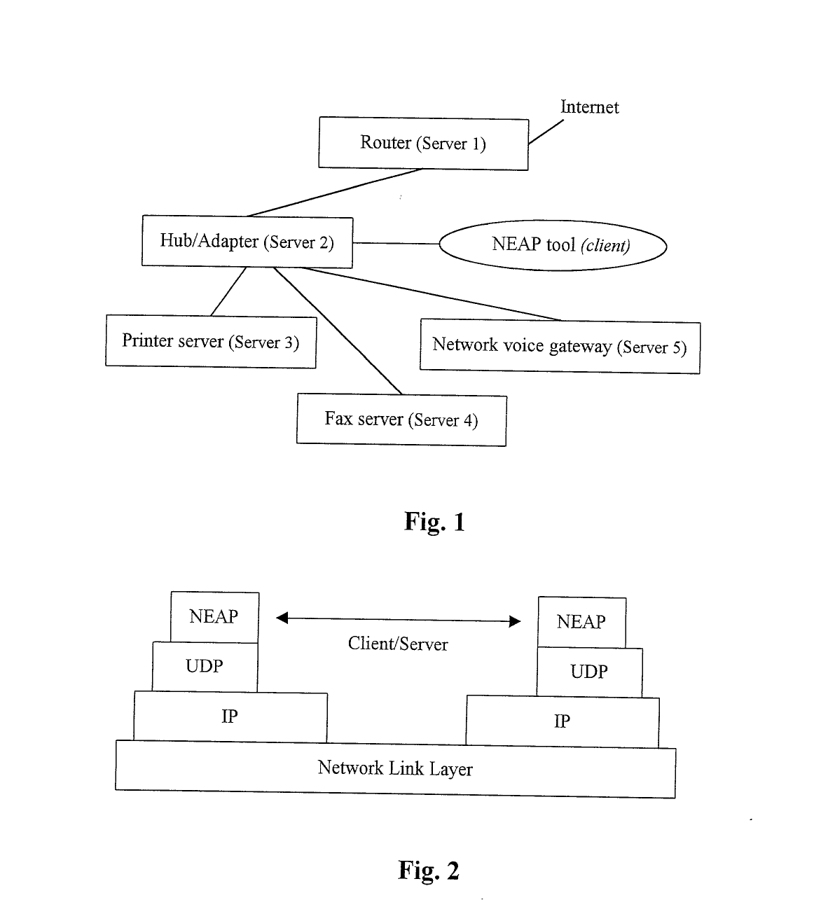

The present invention is a Network Apparatus Management Protocol (or Network Equipment Arrangement Protocol, hereinafter referred as NEAP), the said NEAP is used to enable a management tool of a network apparatus, such as a network management application program, to establish a one-client-multi-server mode together with all the network apparatuses on the same network, such as the router, the hub, the adapter, the printer server, the fax server and the network voice gateway, referring to FIG. 1, and to make the management tool play the role of one-client and the other network apparatuses on the same network play the role of multi-server.

The said NEAP of the present invention mainly utilizes a User Datagram Protocol (hereinafter referred as UDP) of the transport layer inside the ISO/OSI mode, referring to FIG. 2, to enable the said every server, through the said NEAP, to assign a special communication port number in the said UDP header as the port number (such as 0XFC00) for the said every server to be used for receiving the request from the client end; in the said mode, the packet between the client end and the said every server is received and transmitted by broadcasting, that means that all the IP destination addresses of the said servers are set as 255.255.255.255, and the MAC destination addresses thereof are set as FF; FF; FF; FF; FF; FF.

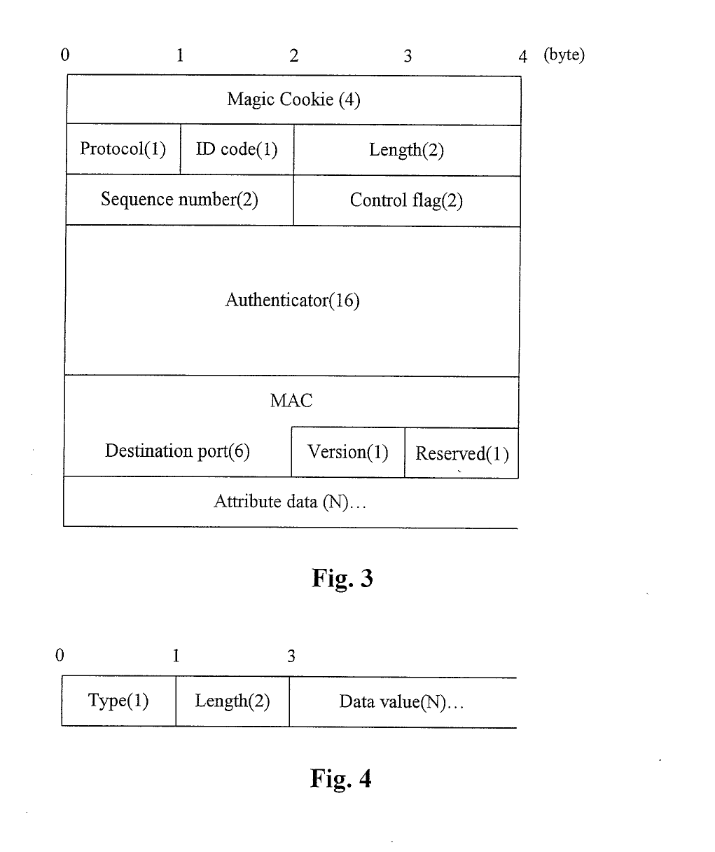

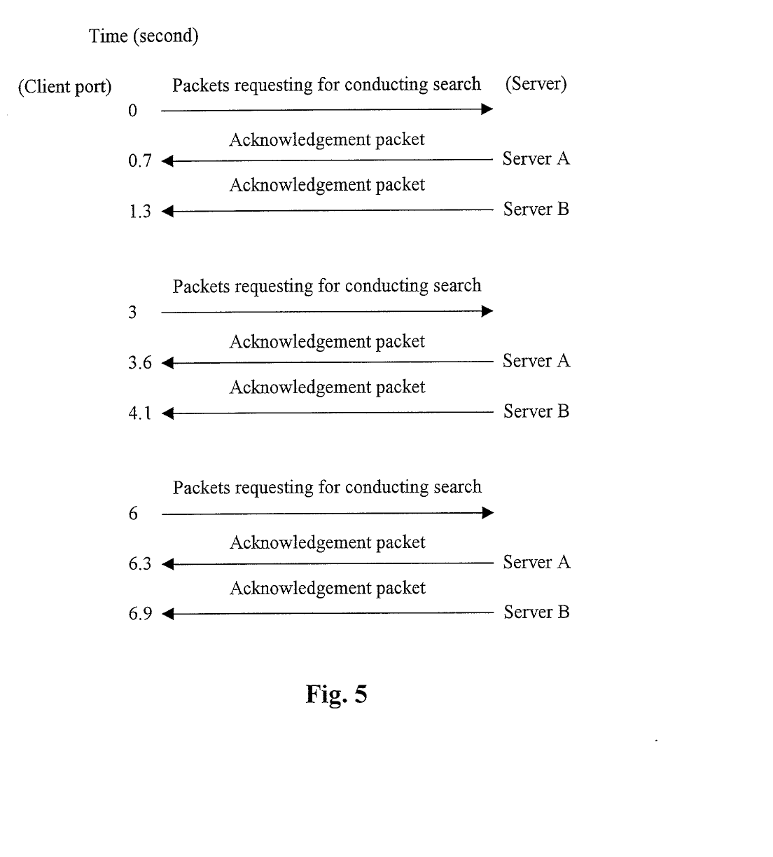

In the present invention, columns for defining data of the packet code and server MAC address are included in the header of the said NEAP, referring to FIG. 3, wherein the said packet code can be divided into three major codes of discovering, getting and setting according to the different destination addresses; the said server MAC address is used to represent the server at the client end requesting for conducting the operations of discovering, getting or setting; the data of the said NEAP includes a series of data columns for defining attributes, referring to FIG. 4, thereby the said attribute data is utilized to describe the data value to be gotten or set.

In the mentioned one-client-multi-server mode, the request packet of the said client end, based on the said NEAP, uses an assigned special UDP communication port number as the UDP destination port number, sets the UDP source port number according to the mechanism of the client end, makes the said every server conduct the requested operation according to the contents of the packet after the said every server receives the said request packet, exchanges the said UDP destination port number and client end installed with the said NEAP is safer and more confidential when the said every network server is conducting the operation of getting and setting.

In the present invention when the client end installed with the said NEAP tends to conduct data getting toward certain specific server installed with the said NEAP, the said client end sequentially fills the data item to be gotten into the data column of the said NEAP according its attribute type, then sends out the request packet; after the said packet being received by the said server (those with the same MAC address as that of the server MAC address column in the said request packet), the said server sequentially decodes the attribute data in the said data column, fills the data in the said server corresponding to the said attribute type in the attribute value column of the said packet according to the attribute type, and transmits the said packet back to the client end to enable the client end to easily get the data in the said server.

Furthermore, when the said client end tends to conduct data setting toward certain specific server, the client end first sequentially fills the data item to be set in the data column of the said NEAP according to the attribute type, then sends out the said request packet; after the packet being received by the said server, the said server sequentially decodes the attribute data in the said data column and sets the set data in the attribute value column to the corresponding position in the said server according to its attribute type to enable the said client end to easily accomplish the setting job for the data in the said server.

1. Network apparatus management Protocol (NEAP), the said NEAP uses a network apparatus management tool to establish a one-client-multi-server mode together with all the network apparatuses on the same network, thereby the said management tool plays the role of one-client and the other network apparatus on the same network play the role of multi-server to make the said every network apparatus, through the said NEAP, assign a special communication port number in the header of a User Datagram Protocol (UDP) as the port number, also to make the request packet of the client end to work as the UDP destination port number based on the UDP communication port number assigned by the said NEAP, and to set the UDP source port number according to the mechanism at the client end, therefore, after receiving the said request packet and accomplishing the operation requested to be conducted, the said every network apparatus exchanges the said UDP destination port number and the said UDP source port number, then transmits it to the client end by broadcasting to enable the said client end to easily achieve the purpose of managing all the said network apparatuses on the same network.

2. Network apparatus management protocol according to claim 1, wherein the columns for defining data of the packet code and server MAC address are included in the header of the said NEAP, wherein the said packet code can be divided into three major codes of discovering, getting and setting according to the different destination addresses; the said server MAC address is used to represent the server at the client end requesting for conducting the operations of discovering, assigning getting or setting.

3. Network apparatus arrangement protocol according to claim 2, wherein the data of the said NEAP includes a series of data columns for defining attributes, thereby the said attribute data is utilized to describe the data value to be gotten or set.

4. Network apparatus arrangement protocol according to claim 3, wherein, when the client end tends to conduct data getting toward the said server, the said client end can sequentially fill in the data item to be gotten into the said data column according to its attribute type, then send out the request packet; after the said packet being received by the said server, the said server sequentially decodes the attribute data in the said data column, fills the data in the said server corresponding to the said attribute type in the attribute value column of the said packet, and transmits the said packet back to the client end to enable the client end to easily get the data in the said server.

5. Network apparatus arrangement protocol according to claim 3, wherein, when the said client end tends to conduct data setting toward the said server, the said client end can first sequentially fill the data item to be set in the said data column according to its attribute type, then send out the said request packet; after the said request packet being received by the said server, the said server sequentially decodes the attribute data in the said data column and sets the set data in the attribute value column to the corresponding position in the said server according to its attribute type to enable the said client end to easily accomplish the setting job for the said server.

6. Network apparatus arrangement protocol according to claim 3, wherein, before sending out the said request packet, the said client end first adds the password to the entire request packet excluding the columns of authenticator and server MAC address according to a set method of code encryption, then fills it in the said authenticator column and sends the said request packet out from the client end; after the request packet being received by the said every server, the said every server uses the same code encryption method to encrypt the entire request packet into data according to the preset password provided by the said every server, compares it with the data in the authenticator column in the said request packet; if both are the same, the operation of getting or setting is conducted; otherwise, the request of the said packet is rejected.
